(19) United States
(12) Patent Application Publication
(10) Pub. No.: US 2026/0070787 A1
(43) Pub. Date: Mar. 12, 2026

(54) MODIFIED BORON NITRIDE POWDER

(71) Applicant: MOMENTIVE PERFORMANCE MATERIALS QUARTZ, INC., Strongsville, OH (US)

(72) Inventors: Jiarui YAN, Solon, OH (US); Bei XIANG, Brecksville, OH (US); Kade McGARRITY, Independence, OH (US)

(21) Appl. No.: 19/325,584

(22) Filed: Sep. 11, 2025

Related U.S. Application Data
(60) Provisional application No. 63/693,764, filed on Sep. 12, 2024.
(60) Provisional application No. 63/827,232, filed on Jun. 20, 2025.

(51) Int. Cl. C01B 21/064; C08K 9/08; C09K 5/14

(52) U.S. Cl. CPC C01B 21/0648; C08K 9/08; C09K 5/14; C01P 2002/76; C01P 2002/82; C01P 2002/85; C01P 2004/03; C01P 2004/20; C01P 2004/50; C01P 2004/61; C01P 2004/62; C01P 2006/22; C01P 2006/32; C08K 2201/001; C08K 2201/005

(57) ABSTRACT

A powder is provided that includes boron nitride particles or agglomerates. Polyethylene glycol-functional compounds are arranged on outer surfaces of the boron nitride particles or agglomerates such that the boron nitride particles or agglomerates have an elevated surface polarity activated by polyethylene glycol-functional compounds.

### RELATED APPLICATIONS

This application claims the benefit of and priority to U.S. Provisional Application No. 63/693,764 filed on Sep. 12, 2024 and U.S. Provisional Application No. 63/827,232 filed on Jun. 20, 2025, each of which are incorporated herein by reference in their entirety.

### TECHNICAL FIELD

In general, the present disclosure relates to a modified boron nitride (BN) powder having a polarized surface.

### BACKGROUND OF THE INVENTION

Boron nitride (BN) offers high thermal conductivity and electrical insulation and thus, is often added to a polymer resin to improve the thermal conductivity thereof. Materials with these thermal management properties are sought after for use in electronics as modern electronic components require increased power and faster data transmission which lead to increased heat and data loss.

### SUMMARY OF THE INVENTION

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

In one aspect, a boron nitride (BN) powder is provided. The BN powder contains particles and/or agglomerates that have an elevated surface polarity activated by polyethylene glycol-functional organics.

In another aspect, a resin composite is provided that includes the BN powder with an elevated surface polarity activated by polyethylene glycol-functional organics.

In yet another aspect, a method of producing BN particles and agglomerates with an elevated surface polarity is provided. The method includes mixing unmodified BN particles and an organic modifier.

These and other aspects will be evident when viewed in light of the drawings, detailed description, and appended claims.

### BRIEF DESCRIPTION OF THE DRAWINGS

Various non-limiting embodiments may take physical form in certain parts and arrangements of parts, which will be described in detail in the specification and illustrated in the accompanying drawings which form a part hereof, and wherein:

FIG. 1 provides a plot containing FTIR data of modified BN powder compared to unmodified BN powder, as will be further described herein.

FIG. 2 provides a graph showing the effect that BN grade and the use of solvent have on the viscosity of a resin composite containing a modified BN powder, as will be further described herein.

FIG. 3 provides a graph showing the effect that BN grade and surface treatment of BN powder have on the thermal conductivity of a resin composite containing a modified BN powder, as will be further described herein.

FIG. 4 provides a graph showing the effect that BN grade and surface treatment of BN powder have on the dielectric breakdown strength of a resin composite, as will be further described herein.

FIGS. 5A and 5B provide plots of thermal conductivity versus viscosity for various samples of resin composites that contain varying amounts and grades of BN powder, as will be further described herein.

FIGS. 6A and 6B provide SEM images of morphologies of BN particles and agglomerates, as will be further described herein.

FIGS. 7A and 7B provide various diagrams illustrating differences in thermal conductivity within resin composites containing modified platelet BN powder compared to those containing modified agglomerate BN powder, as will be further described herein.

### DETAILED DESCRIPTION OF THE INVENTION

As described above, boron nitride (BN) offers excellent thermal conductivity and electrical insulating properties. As such, BN powder is often employed as a filler in polymer resins for use as thermal interface materials to increase thermal conductivity while maintaining electrical insulation (e.g., high dielectric strength and low dielectric constant) and low transmission loss in the BN-polymer resin composite. BN powder, however, may significantly increase the viscosity of the resin composite. The increased viscosity makes industrial processing more difficult. In some instances, a lower amount of BN filler may be used to improve processability. Using less BN filler reduces the thermal management benefits provided. For example, reducing the amount of BN filler may lead to a marginal thermal conductivity boost relative to the pure polymer.

According to an aspect, BN powder with an elevated surface polarity decreases viscosity of a polar resin composite to a workable level and has a better compatibility with the polymer resin of the composite. In other words, the amount of BN powder with surface treatment by an organic modifier may be increased in composites containing a polymer resin matrix without sacrificing processability. More particularly, a modified boron nitride (BN) powder is described that has an elevated surface polarity. The organic modifier may be referred to as a wetting agent as it improves the compatibility between the BN powder and polymer resin. When using the modified BN as a filler in polymers, the uncured composite has a much lower viscosity compared to an uncured composite having unmodified BN; this reduction in viscosity can be up to two orders of magnitude lower without sacrificing thermal conductivity. In some instances, the presence of modified BN powder in a resin composite has a viscosity that is up to 98% lower than the viscosity of a comparable resin composite but containing unmodified BN powder. In addition to viscosity reduction and improved thermal conductivity, the modified BN powder used in a resin composite may further provide thinner bond line thickness, stronger adhesion to metals such as copper, and electrical insulation. As an example, the dielectric breakdown voltage of a cured resin composite comprising modified BN powder improved by 10% compared to a cured resin comprising no BN powder and may be comparable to (within 10%) the dielectric breakdown voltage of a cured resin with unmodified BN powder. The disclosed modified BN powder may be utilized in a variety of industries that benefit from thermal management materials, including but not limited to the electronics, telecommunications, automotive, aerospace, and semiconductor industries. The modified BN powder may be incorporated into various products in these industries, including but not limited to adhesives, pads, potting compounds, thermal interface materials, gap fillers, electronic coatings, dielectric laminates, and the like.

In some examples, the BN powder has an elevated surface polarity activated by polyethylene glycol-functional organics. As noted above, one benefit is that the BN resin composite would have a lower viscosity for easier processing. Similarly, more BN powder could be filled into the polymer resin without compromising the processability of the resin composite. In some embodiments, the modified BN powder comprises particles and/or agglomerates having an average particle size of between about 0.1 μm and about 500 μm, between about 0.5 μm and about 200 μm, or between about 0.5 μm and about 100 μm. Thus, the “average particle size” of the modified BN powder is based on a distribution of particle sizes, where the particle sizes in the distribution can be based on the size of a particle that is not part of an agglomerate or aggregate and/or on the size of an agglomerate or aggregate, which contains several particles. In some instances, the average particle size is measured by a light scattering method.

According to another aspect, to increase the polarity of the BN surface, polyethylene glycol-functional organics are used as a modifier for surface treatment to form the modified BN. In some embodiments, the polyethylene glycol-functional organic compound is a silane modified with polyethylene glycol (PEG) groups. In other embodiments, a polymer backbone other than silane is used, which may be selected based on compatibility with the polymer resin. The PEG group is hydrophilic, which increases the polarity of the BN particle surfaces. The polymer resin may be polar and thus, the modified BN particles/agglomerates, which also have a polarity, interact with the polymer resin to decrease the interfacial energy between the modified BN particles/agglomerates and the polymer resin to decrease the viscosity of the overall polymer composite. The interaction between the BN particles and the modifier to form the modified BN particles/agglomerates is not intended to influence the crystal structure of the unmodified BN particles/agglomerates. Thus, the modified BN powder comprises BN particles and/or agglomerates comprising polyethylene glycol-functional compounds on outer surfaces of the BN particles or agglomerates.

The usage of the modifier may be determined based on characteristics of the BN powder itself. For example, various grades of BN powder have different properties such as specific surface area, particle size, etc. Based on those characteristics of the BN powder, the amount/concentration of the modifier that sufficiently modifies the BN powder for its end use can be determined. Further, the grade of BN powder used to create the modified BN powder may be determined based on the type of polymer resin that the modified BN powder will be mixed with. In some embodiments, the polymer resin comprises epoxies, silicones, polyimides, and composites thereof.

According to another aspect, a resin composite is provided that includes surface polarized BN powder described above and thus, is formed upon mixing unmodified BN powder with a modifier. The surface polarized BN powder has an elevated polarized surface activated by polyethylene glycol-functional organics (modifier). The elevated surface polarity of the modified BN powder improves the compatibility between the modified BN powder and the polymer resin. For example, the viscosity of the resin composite comprising modified BN powder is lower than that of a resin composite comprising unmodified BN. Therefore, more BN powder can be used in the resin composite when the BN powder is modified before the viscosity becomes unworkable to achieve the desired properties (e.g., increased thermal conductivity) of the resin composite. It will be appreciated that the “workability” of the resin depends on the application. Surface treated BN powder includes the modifier and BN particles and/or agglomerates. Accordingly, a total amount of BN solids may be corrected when fabricating a resin composite to ensure the effective thermal filler usage is relatively constant. This enables end-use products to have similar thermal performance.

A cured composite comprises the resin and the modified BN powder distributed throughout the resin. In some embodiments, the amount of modified BN powder in the cured composite is between about 20 wt % and about 70 wt % or between about 30 wt % and about 50 wt %. In some embodiments, the number of parts by mass of organic modifier mixed with 100 parts by mass of unmodified BN powder to form a modified BN powder is between about 0.5 and 50 parts by mass, between about 0.5 and 30 parts by mass, between about 1 and 20 parts by mass, or between about 8 and 20 parts by mass. In an example, the surface polarized BN powder includes at least a portion of boron nitride having flat-plate primary particles. In yet another example, a BN powder comprises a mixture of some unmodified BN powder mixed with some modified BN powder.

In some examples, the modified BN has a hexagonal crystal structure. Hexagonal BN can have a layered structure that forms platelet-shaped BN particles. The platelet-shaped BN particles can provide anisotropic thermal performance, as the platelet-shaped BN particles may align with one another under shear force, which may be useful for some applications. In other applications, isotropic thermal performance can be useful for a more uniform thermal distribution. To achieve a more isotropic thermal performance, the modified BN comprises agglomerates, which contain randomly oriented BN crystals that together result in isotropic thermal properties. Thus, to achieve the desired thermal conductivity properties, the modified BN powder can be formulated as platelet-shaped particles, flat-shaped particles, flake-like particles, agglomerates thereof, aggregates thereof, combinations thereof, and the like.

The modified (i.e. surface treated) BN powder may be introduced into composites using appropriate mixing technology. The modified BN can be formed by centrifugal mixing or by spraying the modifier onto the BN powder while the BN powder is being mechanically agitated to form the modified BN powder. Examples of suitable mixers or agitators to form the modified BN include a rotary batch/drum mixer, a horizontal plow mixer, a high-intensity shear mixer, and the like. The resulting modified BN powder is a dried powder and not a slurry or paste. As a dry powder, the modified BN powder can be distributed well throughout the polymer resin when mixed together.

According to yet another aspect, a method of producing surface polarized BN particles is provided. The method includes mixing unmodified BN powder and an organic modifier. The organic modifier contains polyethylene glycol functional groups. As an example, the modified BN powder may be prepared via centrifugal mixing with a proper mixing speed. The centrifugal mixing method may comprise several steps, including adding a particular amount of unmodified BN powder and a particular amount of the modifier, at a predetermined ratio, into a mixer container of a centrifugal mixer for mixing. The modifier-to-BN powder ratio can be determined based on the BN powder average particle size and associated surface area to ensure that enough modifier is present to coat the surface area of the BN powder. The first mixing step is then performed. The mixing time of the first mixing step may be between about 20 seconds and about 5 minutes at a rotation speed of about 300 rpm to 1500 rpm. After the initial first mixing step, any lumps in the mixed powder may be broken down either manually or through automated tooling. The first mixing step and lump breakdown steps may be repeated until a uniform coating of the modifier is on the BN particles or agglomerates, while controlling particle agglomeration, to form the desired modified BN powder.

The following examples are provided to illustrate the present invention and its advantages but should not be construed as limiting a scope of the invention. EXAMPLE 1 provides data highlighting the effect of BN grade on the properties of a resin composite comprising the modified BN particles; EXAMPLE 2 provides data highlighting the effect of modified BN particle morphology on the properties of a resin composite comprising the modified BN powder.

### Example 1

Two grades of hexagonal BN powders with varying particle sizes and surface areas were formulated and tested. The first grade will be referred to as “NX1” BN powder, which has a smaller particle size and a higher surface area compared to the second grade. The second grade will be referred to as “HCPL” BN powder, which thus has a larger particle size and lower surface area than the NX1 BN powder. Both the NX1 and HCPL BN powders have platelet particles. To illustrate the effect of BN grade on viscosity and thermal conductivity, the NX1 BN powder had an average particle size of about 0.9 μm while the HCPL BN powder had an average particle size of about 10 μm. Both the NX1 BN powder and the HCPL BN powder had overall platelet morphology. The NX1 and HCPL BN powders were then modified through mixing with varying amounts of a same polyethylene-glycol functional organic compound.

As presented herein, various data was collected to illustrate the reliable production of the resin composite containing modified BN powder; to illustrate the composition of the modified BN powder; and to illustrate the effect of BN grade on the properties of a resin composite containing modified BN powder.

Uniformity of each modified BN powder sample (the modified NX1 BN powder and the modified HCPL BN powder) was evaluated by thermogravimetric analysis (TGA) and Fourier transform infrared (FTIR) spectroscopy. To demonstrate the consistency and reproducibility of the TGA data, samples were prepared for each grade at different modifier to BN powder weight ratios. Table 1 below shows TGA mass loss percentage of surface treated (e.g. surface polarized) BN powder. As shown, the different grades of BN or different modifier amounts results in mass loss percentages ranging from approximately 5% to 25% when heated to 800° C. in a nitrogen atmosphere.

TABLE 1
TGA DATA AT 800° C. IN A NITROGEN ATMOSPHERE

| BN grade | Modifier:BN (wt ratio) | Average Mass Loss (%) |
|---|---|---|
| NX1 | 0 | 0% |
| | 1:14 | 5.3% |
| | 1:8 | 9.4% |
| | 1:5 | 14.8% |
| | 1:4 | 17.9% |
| HCPL | 0 | 0% |
| | 1:14 | 5.5% |
| | 1:8 | 10.0% |
| | 1:5 | 14.6% |
| | 1:4 | 17.5% |

TGA can remove about 98% of the weight of the modifier, and thus, the amount of the modifier in a sample of modified BN powder can be controlled during formulation and then verified using TGA at least at the abovementioned conditions. Thus, regardless of the BN particle size and/or the amount of modifier in a modified BN powder, TGA can be reliably used to determine the amount of organic modifier present in a prepared modified BN powder.

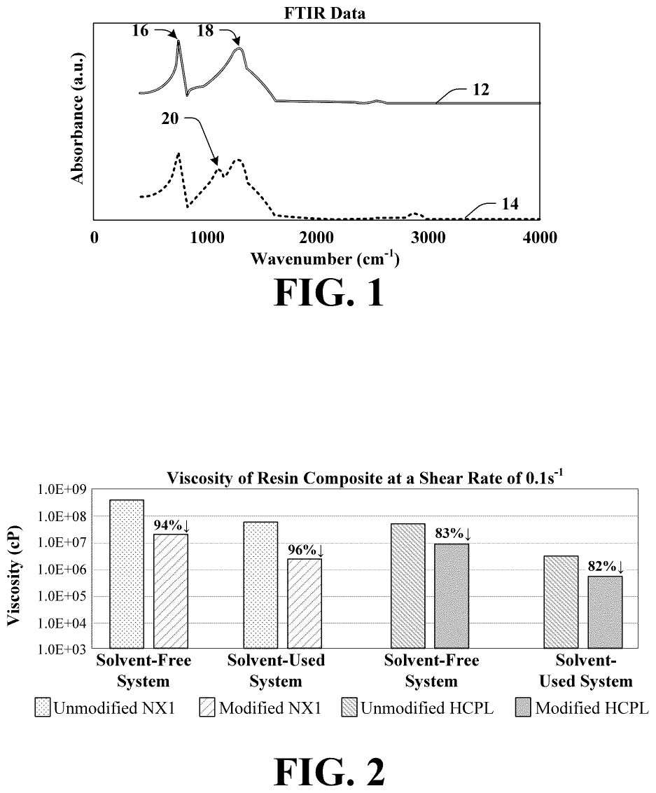

Turning now to FIG. 1, FTIR data of modified BN powder compared to unmodified BN powder is shown. Line 12 corresponds to the FTIR data for the unmodified BN powder, while line 14 corresponds to the FTIR data for the modified BN powder. Both lines 12, 14 have a first peak 16 corresponding to B—N bending and a second peak 18 corresponding to B—N stretching. Line 14 differs from line 12 by having a third peak 20 arranged between the first and second peaks 16, 18. The third peak 20 corresponds to C—O stretching from the organic modifier present in the modified BN powder (line 14) compared to the unmodified BN powder (line 12) which does not contain the organic modifier. The third peak 20 of the modified BN powder on line 14 may be between 1100 and 1300 cm⁻¹, and the second peak 18 of the modified BN powder on line 14 may be between 1270 and 1320 cm⁻¹.

Further, FTIR data was collected on modified BN samples containing differing amounts of the organic modifier, which indicated that the magnitude of the third peak 20 correlates with the amount (wt %) of the organic modifier within the modified BN sample. For example, the peak area ratio of the third peak 20 to the second peak 18 has a correlation to the weight ratio of the modifier to the modified BN powder as shown in TABLE 2. The peak area ratios may range from approximately 0.1 to 1.0 based on different modifier usages.

TABLE 2
FTIR PEAK AREA RATIO DATA

| BN grade | Modifier:BN (wt ratio) | Peak Area Ratio (Modifier:BN) |
|---|---|---|
| NX1 | 0 | 0 |
| | 1:8 | 0.21 |
| | 1:5 | 0.31 |
| | 1:4 | 0.80 |
| HCPL | 0 | 0 |
| | 1:8 | 0.16 |

TABLE 3 indicates carbon content weight percentages of modified (e.g. surface polarized) BN powder collected using LECO analysis, which utilizes oxidative heating in a carbon analyzer. As shown, different grades of BN or different modifier amounts result in a modified BN powder having carbon content percentages ranging from approximately 1% to 10%. As the amount of modifier in the modified BN powder increases, so does the carbon content percentage because the modifier is an organic compound. In some embodiments, the average carbon content in modified BN powder is in a range from approximately 0.1 wt % to 25 wt %, in a range from approximately 0.5 wt % to 15 wt %, or in a range from approximately 1 wt % to 10 wt %.

TABLE 3
CARBON CONTENT

| BN grade | Modifier:BN (wt ratio) | Average Carbon Content (%) |
|---|---|---|
| NX1 | 0 | 0% |
| | 1:14 | 2.7% |
| | 1:8 | 4.3% |
| | 1:5 | 5.6% |
| | 1:4 | 5.3% |
| HCPL | 0 | 0% |
| | 1:14 | 2.6% |
| | 1:8 | 4.5% |
| | 1:5 | 5.6% |
| | 1:4 | 6.0% |

TABLE 4 indicates oil absorption of surface treated (e.g. surface polarized) BN powder. As evidenced by TABLE 4, different grades of BN powder result in oil absorption reduction ranging from approximately 30% to 50% in comparison to an unmodified boron nitride without the elevated surface polarity. TABLE 4 further shows the effect of surface treatment, where a higher surface polarity will be less compatible with oil. The oil absorption data was collected in linseed oil using the Gardner-Coleman Method for oil absorption of pigments (ASTM D1483-12 (2016)).

TABLE 4
OIL ABSORPTION DATA

| | | Oil Absorption | Normalized Oil |
|---|---|---|---|
| BN grade | Treatment | (g/100 g BN) | Absorption (%) |
| NX1 | None (unmodified) | 95.9 | 100% |
| | Surface polarized | 49.8 | 51.9% |
| HCPL | None (unmodified) | 77.2 | 100% |
| | Surface polarized | 53.8 | 69.7% |

TABLE 5 shows x-ray photoelectron spectroscopy (XPS) results of surface treated (e.g. surface polarized) BN powder. TABLE 5 shows the effect of surface treatment for various grades of BN powder. As shown, the surface treated BN powder exhibits surface chemistry having a carbon concentration between approximately 20 to 50 atomic %, oxygen in a concentration ranging from approximately 10 to 30 atomic %, and silicon in a concentration of approximately 0 to 5 atomic %. The silicon source originated from the PEG-modified organic. This is different than the unmodified BN powder samples, which comprise nearly no carbon, oxygen, or silicon on its surface, which confirms that the unmodified BN powder does not contain the organic modifier.

TABLE 5
SURFACE CONTENT

| | | Carbon 1s, | Oxygen 1s, | Silicon 2p, |
|---|---|---|---|---|
| | | atomic | atomic | atomic |
| BN grade | Treatment | number % | number % | number % |
| NX1 | None (unmodified) | 0.6 | 3.4 | 0 |
| | Surface polarized | 27.0 | 16.8 | 0.8 |
| HCPL | None (unmodified) | 2.8 | 3.5 | 0 |
| | Surface polarized | 44.0 | 23.7 | 1.7 |

Various samples of the modified NX1 and HCPL BN powders shown above were mixed with an epoxy resin having a relatively low viscosity to form various samples of resin composites. Properties of these resin composites were then measured to illustrate the effect of BN grade on thermal conductivity and viscosity of a resin composite. In EXAMPLE 1, the modified NX1 and HCPL powders were mixed with the epoxy resin using a centrifugal mixer. The weight percentage of NX1 or HCPL BN solid content in the epoxy composites was about 40%. In other embodiments, the weight percentage of BN solid content in the polymer resin composites can vary and may be, for example, between about 10% and about 90%, between about 20% and 70%, or between 30% and 50%. In some samples as specified, the resin composite further included a polar organic solvent used to dilute the polymer matrix and/or act as a dispersing agent. Examples of such a solvent include acetone.

Turning now to FIG. 2, the viscosities of different resin composites are presented. The viscosity was measured using a rheometer equipped with crosshatch geometry and a crosshatch baseplate to prevent sample slippage during testing. The rheometer was set to ramp the shear rate from 0.001 s⁻¹ to 10 s⁻¹ and viscosity measurements at a shear rate of 0.1 s⁻¹ were recorded in FIG. 2.

As shown in FIG. 2, in a solvent-free resin composite, modifying the NX1 BN powder results in a 94% reduction of viscosity and modifying the HCPL BN powder results in an 83% reduction of viscosity. In some examples, the viscosity of a resin composite was reduced by up to two orders of magnitude when using modified BN powder compared to unmodified BN powder at the same BN solid content amount. Without being bound by theory, it is believed that there is a greater decrease in viscosity of the resin composite comprising the modified NX1 BN powder compared to the modified HCPL BN powder because the modified NX1 BN powder has a smaller particle size and thus, more surface area of BN powder is present for modification by the organic modifier. Similarly, in a resin composite containing an organic polar solvent, modifying the NX1 powder results in a 96% reduction of viscosity and modifying the HCPL powder results in a 82% reduction of viscosity. Thus, even when a solvent is added to dilute the polymer matrix, there is still a significant and comparable decrease in viscosity of the resin composite when modified BN powders are used compared to unmodified BN powders. Further, it was found that the rate of viscosity increase as the amount of modified BN powder in the resin composite is increased was comparable or lower than the rate of viscosity increase as the amount of unmodified BN powder in the resin composite is increased. TABLE 6 provides the raw data associated with the graph of FIG. 2.

TABLE 6
VISCOSITY DATA

| | Viscosity in Solvent- | Viscosity in Solvent- |
|---|---|---|
| BN Grade | Free System (cP) | Used System (cP) |
| Unmodified NX1 | 3.81E+08 | 6.38E+07 |
| Modified NX1 | 2.18E+07 | 2.57E+06 |
| Unmodified HCPL | 5.37E+07 | 3.19E+06 |
| Modified HCPL | 9.28E+06 | 5.83E+05 |

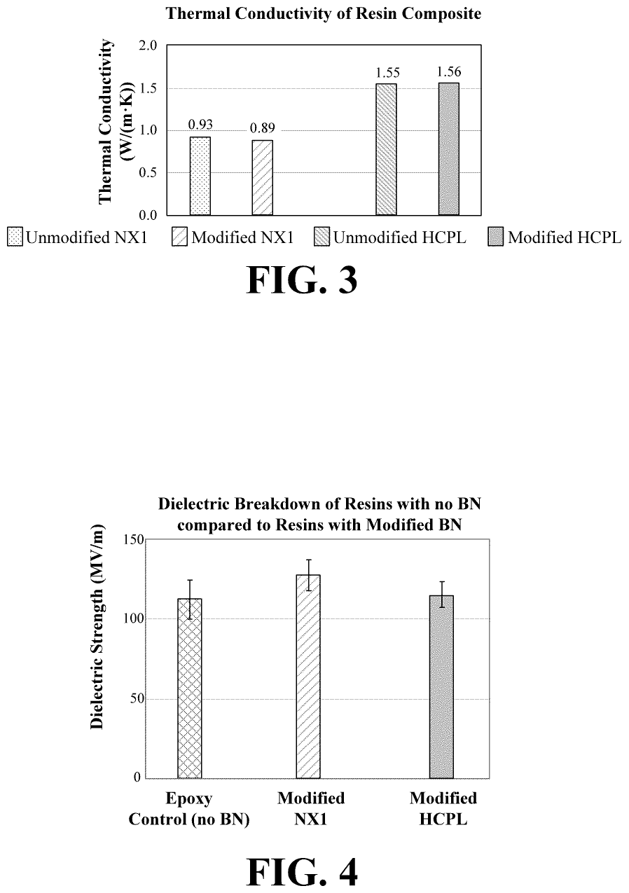

Turning now to FIG. 3, the thermal conductivities of different resin composites are presented. The thermal conductivity was measured using a transient plane source (TPS) method and equipment specifically designed for paste samples. A small amount of the resin composite sample was placed between two rubber washers under 10 N of force. A sensor was arranged between the rubber washers in contact with the resin composite sample.

As shown in FIG. 3, the thermal conductivity of a resin composite containing unmodified BN powder has a very comparable thermal conductivity of a resin composite containing a modified BN powder. FIG. 3 also shows that at the same solid BN weight percentage loading, the thermal conductivity increases with increasing average particle size of the BN powder. Because the modified BN powder has a lower effect on the viscosity of the resin composite, more modified BN powder can be used in the resin composite to provide an elevated thermal conductivity compared to unmodified BN powder.

Turning additionally to FIG. 4, the dielectric breakdown strength of a cured resin containing modified BN powder is compared to a cured control resin containing no BN powder. FIG. 4 shows that the modified BN powder, such as modified NX1, can improve the dielectric strength of the cured resin by over 10%. When the particles are larger, the cured resin with modified BN powder (e.g., modified HCPL), can have a slighter improved or at least comparable dielectric strength as the cured resin without the BN powder. Thus, the presence of modified BN powder in the cured resin does not negatively impact the dielectric strength of the cured resin. Further, the dielectric breakdown strength of cured resins with modified BN powder were found to be comparable to (within 10% of) the dielectric breakdown strength of cured resins with unmodified BN powder. The cured resin with modified BN powder can have a dielectric breakdown strength between 50 MV/m and 150 MV/m, between 100 MV/m and 200 MV/m, or between 100 MV/m and 130 MV/m.

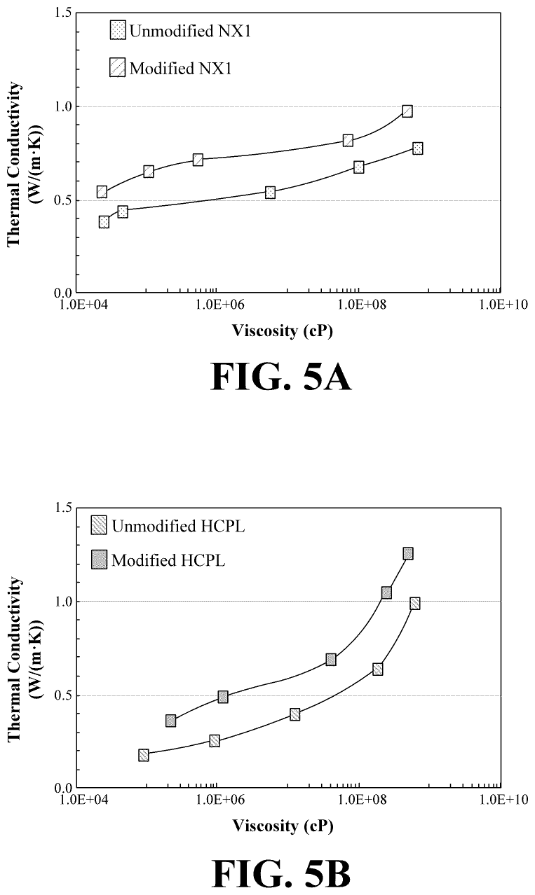

Turning additionally to FIGS. 5A and 5B, plots of thermal conductivity versus viscosity are provided to show that regardless of the BN grade, a resin composite that includes modified BN powder provides a greater thermal conductivity at a lower viscosity compared to a resin composite that includes an unmodified BN powder of the same grade. In particular, FIG. 5A provides data for a resin composite comprising unmodified NX1 BN powder compared to a resin composite comprising modified NX1 BN powder. FIG. 5B provides data for a resin composite comprising unmodified HCPL BN powder compared to a resin composite comprising modified HCPL BN powder. In particular, each successive data point on each line in FIGS. 5A and 5B represents the measured thermal conductivity and viscosity values as an increasing amount of the associated BN powder is added to the respective resin composite. Because the modified BN powder can provide a resin composite having a particular thermal conductivity at a significantly lower viscosity compared to those formulated with unmodified BN powders, substantially more modified BN powder can be added to a resin composite to achieve a higher thermal conductivity without sacrificing viscosity compared to a resin composite comprising an unmodified BN powder. In fact, in some embodiments, the modified BN powder can improve the thermal conductivity of a resin composite by over 25% at a same viscosity as a resin composite containing unmodified BN powder.

### Example 2

Various samples of modified BN powders with different morphologies were formulated and tested. Some samples contained BN platelets, while other samples contained BN agglomerates. Further, the various samples contained different average particles sizes. The various sizes of platelet and agglomerated modified BN powders were incorporated into an epoxy resin to form several samples of resin composites. A crosslinker was also added to the resin composite to facilitate curing of the polymer resin. Thus, in some embodiments, the resin composite is formed from a modified BN powder, a polymer resin, and a crosslinker.

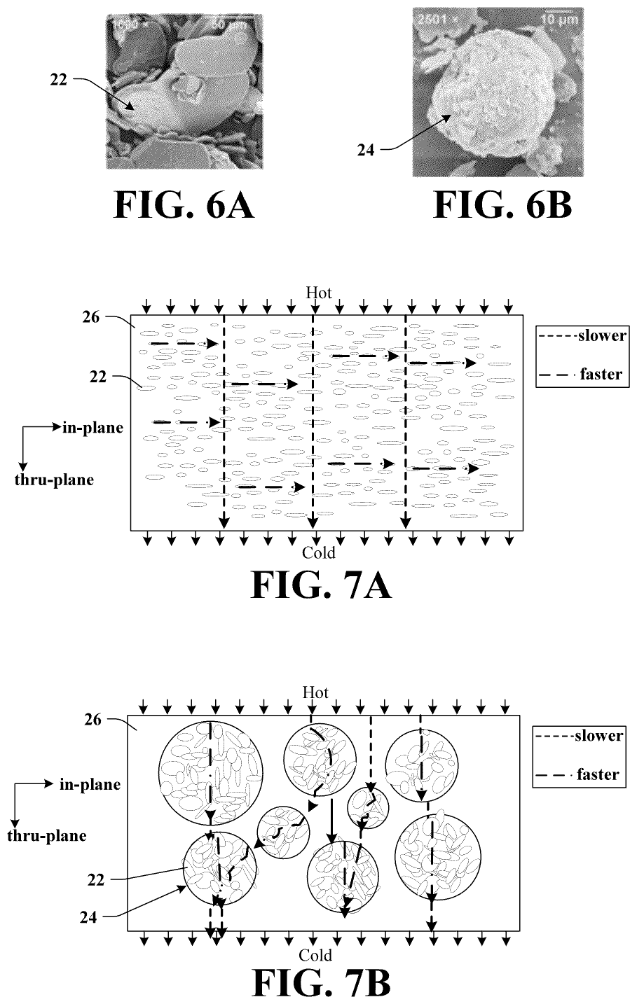

FIG. 6A illustrates a scanning electron microscopy (SEM) image of a platelet particle 22 for use in a BN powder, and FIG. 6B illustrates a SEM image of an agglomerate 24 having a spherical shape for use in a BN powder. When comparing FIG. 6A to FIG. 6B, the platelet BN particle 22 has an asymmetric, flat shape, whereas the spherical BN agglomerate 24 in FIG. 6B has a substantially symmetric, rounded shape. When a BN agglomerate 24 is treated with the modifier, the outer surface of the BN agglomerate 24 is targeted. Because the BN agglomerates 24 are porous, some modifier may penetrate outer surfaces of the BN agglomerate 24 such that some inner surfaces of the BN agglomerate 24, defined in part by BN platelet particles 22, also are treated with the modifier.

FIG. 7A provides a schematic of thermal energy traveling through a layer of a resin composite 26 comprising a modified BN powder comprising platelet particles 22, while FIG. 7B provides a schematic of thermal energy traveling through a layer of resin composite 26 comprising a modified BN powder comprising agglomerates 24. The “thru-plane” direction is labeled, which corresponds to the thickness of the layer of the resin composite 26, while the “in-plane” direction is labeled, which corresponds to a length of the layer of the resin composite 26. The thru-plane direction is perpendicular to the in-plane direction. As shown by the arrows and hot/cold labels representing thermal energy in FIGS. 7A and 7B, thermal energy builds up at the top surface of the layer 26 and ideally travels in the thru-plane direction towards the cold surface to escape from the layer 26 in an efficient manner. The modified BN powder containing the agglomerates 24 of FIG. 7B provide nearly equal thermal conductivity in all directions (showing an overall isotropic thermal conductivity) compared to the modified BN powder containing the flat platelets 22 of FIG. 7A. More particularly, FIG. 7A shows that the thermal conductivity is much more efficient (faster) in the in-plane direction along the alignment of the platelets 22 compared the speed of thermal conductivity in the thru-plane direction (slower). The “faster” arrows within each layer of the resin composite 26 show how thermal energy travels more efficiently through the layer of the resin composite 26 compared to when the thermal energy travels through the polymer resin matrix, as indicated by the “slower” arrows.

The varying particle sizes of the platelets 22 in FIG. 7A also illustrates the distribution of particle sizes within a same layer of resin composite 26, which is quantified by way of the average particle size. FIG. 7B shows that the thermal conductivity is more efficient through the agglomerates 24 than through the matrix of the resin composite 26. The agglomerates comprise various particles, such as the platelets 22, that together form an agglomerate 24 that, in FIG. 7B, has an overall spherical shape. In other embodiments, the agglomerates 24 may have other overall shapes and/or be made from other shaped particles.

The following are non-limited examples of some embodiments of the present disclosure:

Embodiment 1. A powder comprising:
boron nitride particles or agglomerates having an elevated surface polarity activated by polyethylene glycol-functional compounds arranged on outer surfaces of the boron nitride particles or agglomerates.

Embodiment 2. The powder of Embodiment 1, wherein the boron nitride has a hexagonal crystal structure.

Embodiment 3. The powder of Embodiment 1, wherein the boron nitride includes flat-plate primary particles.

Embodiment 4. The powder of Embodiment 1, wherein the boron nitride particles or agglomerates have an average particle size of between about 0.1 μm and about 500 μm.

Embodiment 5. The powder of Embodiment 1 comprising the boron nitride agglomerates.

Embodiment 6. The powder of Embodiment 1, wherein an FTIR spectrum of the powder exhibits a first peak between 1100 and 1300 cm⁻¹ and a second peak between 1270 and 1320 cm⁻¹.

Embodiment 7. The powder of Embodiment 1, wherein the powder exhibits mass loss of between 5 and 25% of the powder's original mass after heating to 800° C. in nitrogen.

Embodiment 8. The powder of Embodiment 1, wherein the powder contains carbon in a concentration of 0.1-25 wt % as measured by oxidative heating in a LECO carbon analyzer.

Embodiment 9. The powder of Embodiment 1, wherein the powder exhibits a reduction in linseed oil absorption of between 30 and 50% when subjected to the Gardner-Coleman Method for oil absorption of pigments (ASTM D1483-12 (2016)) in comparison to unmodified boron nitride powder without the elevated surface polarity.

Embodiment 10. The powder of Embodiment 1, wherein the powder exhibits surface chemistry including carbon in a concentration between 20 and 50 atomic %, oxygen in a concentration of between 10 and 30 atomic %, and silicon in a concentration of between 0 and 5 atomic % by x-ray photoelectron spectroscopy (XPS).

Embodiment 11. The powder of Embodiment 1, wherein the polyethylene glycol-functional compounds are used in an amount from 0.5 parts by mass to 50 parts by mass per 100 parts by mass of the boron nitride particles or agglomerates.

Embodiment 12. The powder of Embodiment 1, wherein the polyethylene glycol-functional compounds comprise a silane.

Embodiment 13. A cured composite comprising:
a resin; and
the powder of Embodiment 1 distributed throughout the resin.

Embodiment 14. The cured composite of Embodiment 13, wherein the cured composite has a dielectric breakdown strength between 50 MV/m and 150 MV/m.

Embodiment 15. The cured composite of Embodiment 13, wherein the amount of powder in the cured composite is between about 20 wt % and about 70 wt %.

Embodiment 16. The cured composite of Embodiment 13, wherein the resin is at least one of an epoxy resin, a silicone resin, or a polyimide resin.

Embodiment 17. A method of producing a modified boron nitride powder, the method comprising:
mixing a powder comprising boron nitride with an organic modifier to elevate the surface polarity of the boron nitride within the powder to produce the modified boron nitride powder.

Embodiment 18. The method of Embodiment 17, wherein the organic modifier includes polyethylene glycol functional groups.

Embodiment 19. The method of Embodiment 17, wherein the modified boron nitride powder comprises flat-plate primary particles, agglomerates, or a combination thereof.

Embodiment 20. The method of Embodiment 17, wherein the modifier is used in an amount from 0.5 parts by mass to 50 parts by mass per 100 parts by mass of the powder.

Various properties and characteristics of a surface treatment BN powder utilizing an organic modifier have been described above in the figures and tables. The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe e such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A powder comprising:
boron nitride particles or agglomerates having an elevated surface polarity activated by polyethylene glycol-functional compounds arranged on outer surfaces of the boron nitride particles or agglomerates.

2. The powder of claim 1, wherein the boron nitride has a hexagonal crystal structure.

3. The powder of claim 1, wherein the boron nitride includes flat-plate primary particles.

4. The powder of claim 1, wherein the boron nitride particles or agglomerates have an average particle size of between about 0.1 μm and about 500 μm.

5. The powder of claim 1 comprising the boron nitride agglomerates.

6. The powder of claim 1, wherein an FTIR spectrum of the powder exhibits a first peak between 1100 and 1300 cm⁻¹ and a second peak between 1270 and 1320 cm⁻¹.

7. The powder of claim 1, wherein the powder exhibits mass loss of between 5 and 25% of the powder's original mass after heating to 800° C. in nitrogen.

8. The powder of claim 1, wherein the powder contains carbon in a concentration of 0.1-25 wt % as measured by oxidative heating in a LECO carbon analyzer.

9. The powder of claim 1, wherein the powder exhibits a reduction in linseed oil absorption of between 30 and 50% when subjected to the Gardner-Coleman Method for oil absorption of pigments (ASTM D1483-12 (2016)) in comparison to unmodified boron nitride powder without the elevated surface polarity.

10. The powder of claim 1, wherein the powder exhibits surface chemistry including carbon in a concentration between 20 and 50 atomic %, oxygen in a concentration of between 10 and 30 atomic %, and silicon in a concentration of between 0 and 5 atomic % by x-ray photoelectron spectroscopy (XPS).

11. The powder of claim 1, wherein the polyethylene glycol-functional compounds are used in an amount from 0.5 parts by mass to 50 parts by mass per 100 parts by mass of the boron nitride particles or agglomerates.

12. The powder of claim 1, wherein the polyethylene glycol-functional compounds comprise a silane.

13. A cured composite comprising:
a resin; and
the powder of claim 1 distributed throughout the resin.

14. The cured composite of claim 13, wherein the cured composite has a dielectric breakdown strength between 50 MV/m and 150 MV/m.

15. The cured composite of claim 13, wherein the amount of powder in the cured composite is between about 20 wt % and about 70 wt %.

16. The cured composite of claim 13, wherein the resin is at least one of an epoxy resin, a silicone resin, or a polyimide resin.

17. A method of producing a modified boron nitride powder, the method comprising:
mixing a powder comprising boron nitride with an organic modifier to elevate the surface polarity of the boron nitride within the powder to produce the modified boron nitride powder.

18. The method of claim 17, wherein the organic modifier includes polyethylene glycol functional groups.

19. The method of claim 17, wherein the modified boron nitride powder comprises flat-plate primary particles, agglomerates, or a combination thereof.

20. The method of claim 17, wherein the modifier is used in an amount from 0.5 parts by mass to 50 parts by mass per 100 parts by mass of the powder.
